(19) United States
(12) Patent Application Publication
(10) Pub. No.: US 2019/0338900 A1
(43) Pub. Date: Nov. 7, 2019

(54) APPARATUS AND METHODS OF IMPROVEMENT OF SOLAR LIGHT LANTERNS

(71) Applicant: Karen Benninghoff, Chicago, IL (US)

(72) Inventor: Karen Benninghoff, Chicago, IL (US)

(21) Appl. No.: 16/393,414

(22) Filed: Apr. 24, 2019

Related U.S. Application Data
(60) Provisional application No. 62/661,689, filed on Apr. 24, 2018.

(51) Int. Cl. F21L 27/00; F21L 19/00; F21L 4/08; F21V 23/04

(52) U.S. Cl. CPC F21L 27/00; F21L 19/00; F21V 23/0464; F21V 23/0414; F21L 4/08

(57) ABSTRACT

This disclosure relates to an improvement in lighting fixtures, and particularly to tubular hot or cold blast lanterns, and is equally applicable to lighting fixtures manufactured to illuminate utilizing energy sources such as kerosene, fuel, gas, propane, electric or wax. A system and method are disclosed to convert conventional fuel lanterns to solar lanterns with modification of traditional illumination components.

### CROSS-REFERENCE TO RELATED APPLICATION

This application claims the benefit of U.S. Provisional Application No. 62/661,689, filed Apr. 24, 2018, which is incorporated by reference herein.

### FIELD OF THE DISCLOSURE

This invention relates to an improvement in lanterns, and particularly to tubular lanterns, also commonly known as hurricane lanterns or hot or cold blast lanterns and is equally applicable to lanterns designed to light utilizing energy sources such as kerosene, gas, electric, candle or solar power.

### BACKGROUND OF INVENTION

Conventional lanterns require a fuel, candle, electric or gas source. In the case of kerosene or fuel and candle lanterns, fuel or wax and its replacement is required, as is the need to manually ignite and extinguish to turn light on and off. Fuel driven lanterns exude substantial heat which may not be ideal for certain locations. In addition, care must be taken so as not to impose a fire hazard.

Electric lanterns require wiring to an electrical power source and a timer, photo sensor or the need to manually turn on and off. Gas driven lanterns require a gas source, piping to the fixture and, by nature of that traditional arrangement, are usually in the on or lit position constantly burning. All the above-mentioned sources represent continual recurring costs by way of replacement of fuel, candles, electrical kilowatts or gas therms used, plus corresponding delivery charges and tax.

For the above reasons, solar lanterns are an eco-friendly, automatic, non-utility consuming alternative to lighting needs. Conventional solar lanterns currently available on the market have been found to be unreliable in their ability to withstand all outdoor climates and extreme wind and weather conditions. By nature of their design and current technology, their lifetime lighting longevity is limited. Current solar lanterns are constructed such that when the solar light components fail, the entire solar lantern is rendered useless, primarily destined to landfill.

### BRIEF SUMMARY OF THE INVENTION

This invention converts or constructs with improvements, a lantern typically requiring a kerosene, fuel, candle, electricity or gas source to a high quality solar powered lantern made to withstand extreme weather conditions in all climates while providing carefree, reliable, eco-friendly, cost effective lighting for years to come. This invention especially conducive for areas exposed to extreme temperatures, precipitation and wind and may be used outdoors virtually anywhere worldwide.

This invention provides for a secure yet accessible fit of independent solar light bulb within the lantern providing ability to replace or upgrade its independent solar light bulb and/or its rechargeable battery. It is anticipated significant improvements to solar light bulbs and rechargeable batteries will be made in the future. As each solar light bulb is independent of the lantern, the solar light bulb and its batteries may be upgraded at any time while retaining the solar lantern fixture. This invention, by virtue of its solar light, does not throw off any heat or require outside fuel or utility sources. The independent solar light bulb reliably charges in ambient daylight and its sensors activate light each night. In addition to providing beautiful, carefree ambient outdoor lighting, the invention may be placed outside in daylight and brought indoors to provide reliable light, especially valuable in remote areas.

For purposes of example, the present invention illustrated and described utilizing lanterns known as cold blast tubular lanterns and the utilization of solar lights currently available on the retail/open market. This invention encompasses the described improvements to invention and improvement characteristics and methodology of which any or all may be applied, as appropriate, to any fuel, candle, electric, gas or solar lantern.

U.S. Pat. No. 705,816, generally considered as among one of the first patented lanterns of this type, and incorporating all patented variations of original lantern patent, is incorporated and referenced herein by way of example as variations of same currently being produced and available to the general public, including, but not limited to, R. E. Dietz Wizard, Blizzard, Junior, D-Lite, etc. Hurricane lanterns; Feuerhand Hurricane lanterns; and, W. T. Kirkman Tubular Oil Lanterns. The tubular lantern style is selected as example for the present invention as its overall design, weight and construction proven to be extremely stable in high wind and extreme weather conditions.

U.S. Pat. Nos. 7,196,477 and formerly, 7,377,667, 7,429,827, 8,362,700, 8514,094 and 10,132,015 reference generally the type of solar light utilized in the present invention containing or comprised of one more solar cells aka amorphous solar panel, light emitting diode(s) “(LED”s), rechargeable battery arranged to supply power to the LEDs, clear glass lens of approximately 2.36″ in diameter, and parts thereof, commonly marketed and each utilizing one AAA rechargeable battery in its commonly sized and placed battery housing, referred herein as “Petite” describing overall size. Larger, and more powerful, variations of these solar lights are available with a glass crackle globe lens of approximately 3.15″ diameter, each utilizing one AA rechargeable battery in its larger commonly sized and placed battery housing, herein referred to as “Large”.

For purposes of the present invention, either size solar light referenced may be used as appropriate to solar lantern and not meant to be limited to these particular brands or models. An improvement to the present invention is that the battery housing for both Petite and Large solar lights referenced remain uniformly sized for its corresponding rechargeable battery and be utilized to establish two universal standard sizes. These solar lights may now be known as Large and Petite Solar Light Bulbs for use in solar lanterns. It is noted the Petite size solar light bulb universally fits all lantern globe sizes wherein the Large solar light bulb is limited to a globe with an opening width of larger than 3.17″. For purposes of the present invention to ensure uniform fit within any lantern globe, petite solar light bulbs are referenced and not meant to be limited to this particular size or referenced models. An improvement to the invention is to modify the clear crackle ball glass lens of the two standard size solar light bulbs to more closely resemble candle flame or flower bud, combination of both, or other design pleasing for use in solar lantern, and reduce the width of the more powerful Large solar light bulb yet retain the power so it may be utilized in either size globe.

The present invention provides an improvement to lanterns rendering the lantern agreeable to accept an independent solar light bulb for secure yet removable fit within the lantern globe. In the case of fuel, gas and electric lanterns, removal of the burner assembly or electrical components renders the lantern able to accept the independent solar light bulb. An addition of a flange, or partial cover to the base burner well, provides precipitation and debris deflection while maintaining the lantern's classic design. Having the solar light bulb placed within the globe beneficial in that the glass globe reflects, protects and enhances the independent solar light bulb's brilliance. Over a period of many years it is expected the lantern will outlast the solar light bulb. Thus, an improvement is to contain the solar light bulb within the lantern and globe and provide the ability to replace or upgrade the independent solar light bulb and/or its battery at any time while retaining the lantern over a period of many years.

The present invention relates to an improvement to lanterns whereby appropriate drainage/air holes are incorporated in the lantern base plate and burner well at their lowest levels when upright ensuring water does not accumulate around the solar light bulb battery housing. Drain holes and placement in the present invention eliminates that issue. Metal tends to produce condensation in humid conditions and the lanterns, by virtue of being outdoors, will be subjected to precipitation in form of rain, snow and sleet. By incorporating appropriate drainage in the lantern as the present invention describes, moisture accumulation will be nominal, thereby preventing/deterring rust, eliminating ice expansion and resulting damage. In addition, drain holes added to the base and base burner well also serve as air holes contributing to air movement within the lantern further encouraging evaporation of any moisture.

Another object of the present invention is to ensure maximum preservation of the solar lantern as exposed to outdoor elements by ensuring an exterior finish in clear or color has been or is applied to all metal parts of the lantern and, if appropriate, to the housing of the independent solar light bulb. This improvement to invention of exterior color finish particularly conducive to associating with product, sports or theme branding, broadening the consumer audience and appealing to collectors of same. Further, decals manufactured for outdoor use may be added to base and globe in representation of brand or theme.

An improvement to invention is to suggest the NiCd (nickel cadmium) rechargeable battery currently provided with the solar light bulb be replaced with the environmentally friendly NiMh (Nickel Metal Hydride) battery. While current NiCd batteries have a life of approximately 500 hours, or one and a half years of daily use, NiMh batteries not only deliver more power lasting longer in high drain devices, but can be charged up to 1000 times providing three to four years of daily use. NiMH batteries are free of toxic or hazardous elements such as cadmium, lead, mercury or lithium and can be disposed of safely. It is anticipated improvements will be made to rechargeable batteries in the future. An improvement to the present invention is to allow for such future upgrades. An improvement to the present invention is that components comprising solar light bulb be recyclable.

### BRIEF DESCRIPTION OF THE DRAWINGS

FIG. 1 is a front elevational view illustrating a hot or cold blast lantern constructed in accordance with the principles of the invention.

FIG. 2 is an exploded overhead view of the base/lower unit of a traditional hot or cold blast lantern, certain components of which are contained and some of which eliminated in lantern of FIG. 1.

FIG. 3 is an exploded side view of certain components of FIG. 2.

FIG. 4 is an exploded overhead view of the base/lower components of the lantern of FIG. 1 illustrating an improvement and sample method of said improvement.

FIG. 5 is underneath view of the bottom base plate of the lantern of FIG. 1 illustrating certain improvements to lantern.

FIG. 6 is an exploded overhead view of the base/lower components of the lantern of FIG. 1 illustrating an improvement to invention.

FIG. 7 is an exploded overhead view illustrating alternative component of lantern of FIGS. 1 and 6.

FIG. 8 is an exploded side view of component as illustrated in FIGS. 6 and 7 and lantern of FIG. 1.

FIG. 9 is an exploded overhead view of the base/lower components illustrating alternative component to lantern of FIG. 1.

FIG. 10 is a side view of component referenced in FIG. 9 illustrating adaptations to said component as may be used as component of lantern of FIG. 1.

FIG. 11 is a side view of alternative component as referenced in FIGS. 9 and 10 as may be used as component of lantern of FIG. 1.

FIG. 12 is an exploded overhead view of alternative component referenced in FIGS. 9, 10 and 11 as may be used as component of lantern of FIG. 1.

FIG. 13 is a front elevational side view illustrating component of invention of FIG. 1, improvements to which and further detailed in FIGS. 6-19.

FIG. 14 is a side view of illustrating an alternative improvement and sample method of said improvement of lantern of FIG. 1.

FIG. 15 is a side view of illustrating an alternative improvement and sample method of said improvement of lantern of FIG. 1.

FIG. 16 is an exploded overhead view illustrating method of assembling certain components of lantern of FIGS. 1 and 19.

FIG. 17 is an exploded overhead view illustrating alternative method of assembling certain components of lantern of FIGS. 1 and 19.

FIG. 18 is an exploded overhead view of certain components of the lantern of FIGS. 1 and 19 illustrating an improvement to invention.

FIG. 19 is a front elevational view illustrating solar lantern constructed in accordance with the principles of the invention as detailed in FIGS. 1, 4-6, 13-18.

### DETAILED DESCRIPTION OF THE INVENTION

For purposes of example, the present invention is illustrated and described utilizing lanterns known as cold blast lanterns and solar lights currently manufactured and available on the open market. The present invention encompasses the described improvements to invention and improvement characteristic and methodology of which any or all may be applied, as appropriate, to any fuel, candle, electric, gas, hot blast, mantle, flat wick, central draft (tubular round wick), barn or hurricane lantern for like results. The present invention addresses new production modifying lantern components as currently produced and the conversion of antique, vintage or lanterns already produced.

Turning now to the drawings, which describe the presently preferred embodiments of the present invention for the purpose of illustrating the practice thereof, and not by way of limitation of the scope of the present invention, and in which like reference characters refer to corresponding elements through the views referenced.

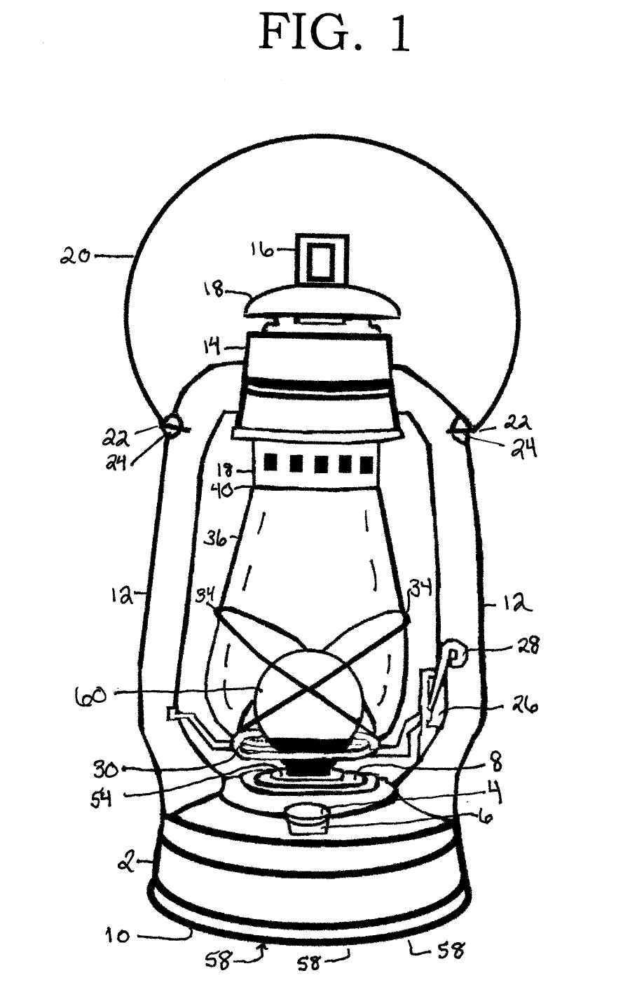

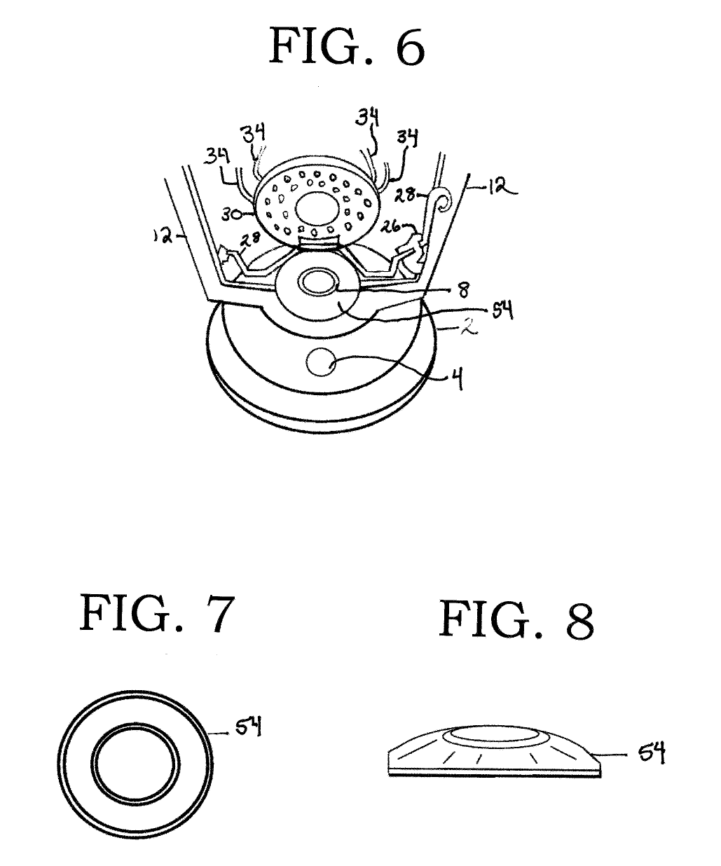

FIG. 1 comprises the improvement to the present invention in its assembled and ready for use state illustrating a traditional cold blast lantern and its commonly used components of same with improvements to invention. Components are generally described as: oil pot/base 2 (“base 2”) with lower base plate 10, base burner well 8 and fuel tank opening 6 attached to open side tubes 12, for the purpose of air flow throughout, leading into and attached to open cylindrical top 14. Spring pressed chimney globe holder 18 (“chimney 18”) fits vertically into top 14 into which globe top rim 40 of globe 36 inserted and held firmly. Attached to one of two lower side tubes 12 is lift collar notch 26 through which lift lever assembly 28 is threaded. Lift lever assembly 28 attached to globe supporting plate 30, herein incorporating attached hinge, to which wire globe guards 34 attached, for purpose of holding globe 36 and used to raise globe supporting plate 30 in order to remove or insert globe 36 and, formerly, access wick 48 for lighting. Bail ears 22, at outer ends of bail handle 20, inserted into bail ears slots 24 molded into upper side tubes 12 for purpose of suspension or portability; ring tab with hinge 16 attached to top chimney 18 to aid in raising chimney 18 within top 14. Base flange 54, an improvement to the present invention, over base burner well 8 as shown and detailed in FIGS. 6-12, 14, 16-19. Inside globe 36, as seated on globe supporting plate 30, solar light bulb 60 with its battery housing 68 positioned vertically downward through globe plate center hole 32, through base flange 54 and base burner well 8 into base 2 (components of which further detailed in FIGS. 1, 2, 4 18). Screw cap 4 attached to fuel tank opening 6 in upper base 2, or a part of base 2, not a necessary component to the present invention, however, incorporated as commonly included in base 2 in ordinary and current production. Drain holes 58, identified as being located under base 2, an improvement to the present invention further described in FIGS. 1, 4-5.

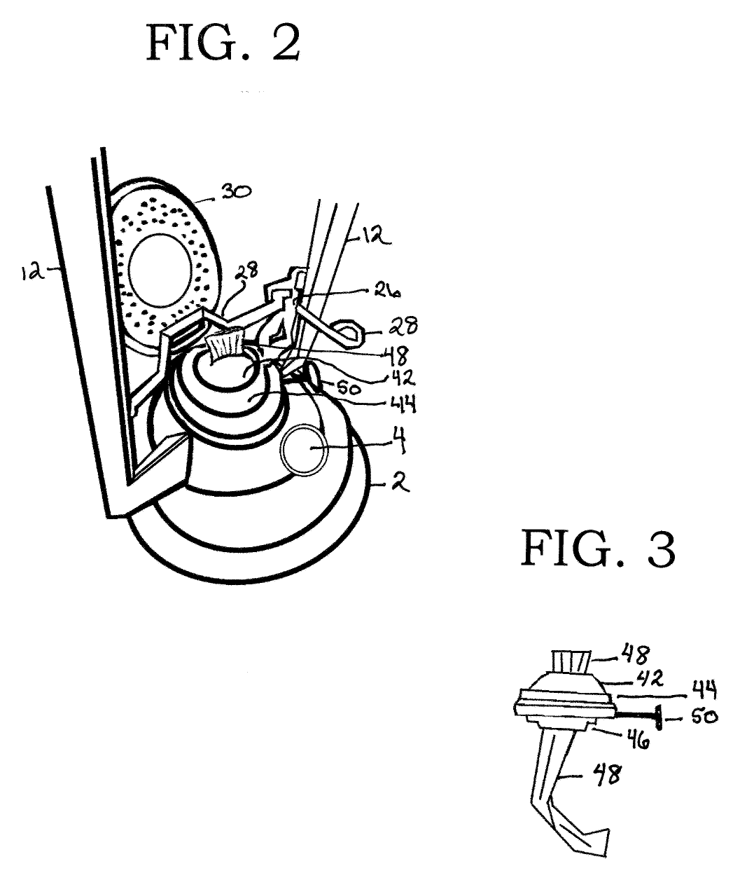

FIG. 2 is lower lantern unit specifically base 2 illustrating common burner assembly 52 components comprised of burner cone 42, burner collar 44, burner wick shaft with latching assembly 46, wick 48 and key 50 (“common burner assembly 52”) as traditionally attached to fuel burning lanterns of this type. FIG. 2 incorporates for perspective purposes tubes 12, globe supporting plate 30, lift lever assembly 28 and screw cap 4. For the purpose of providing partial housing for independent solar light bulb 60, common burner assembly 52 is removed or unscrewed from base burner well 8 of post-production lantern and eliminated in production of solar lantern. Conversely, a gas burner assembly or electric component aka common burner assembly 52 is removed from post production and not included in production of solar lantern. Once common burner assembly 52, gas or electric component removed, base burner well 8, a concave well as molded or attached to top center base 2 for purpose of catching fuel overspill and attachment of common burner assembly 52, and its center opening into base 2, will be exposed.

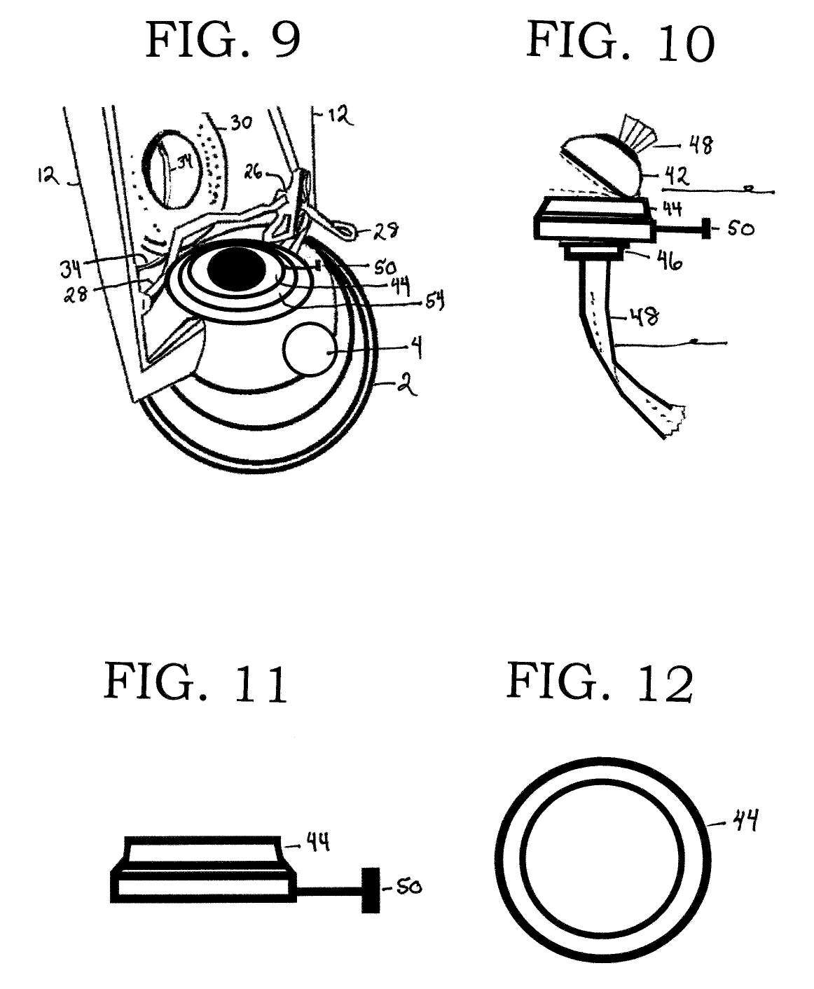

FIG. 3 illustrates a common burner assembly 52 comprised of burner cone 42, burner collar 44, burner wick shaft with latching assembly 46, wick 48 and key 50, incorporating variations in and of common burner assembly 52 components, either removed from base 2 in its entirety or removed and adapted as detailed in FIGS. 9 through 12.

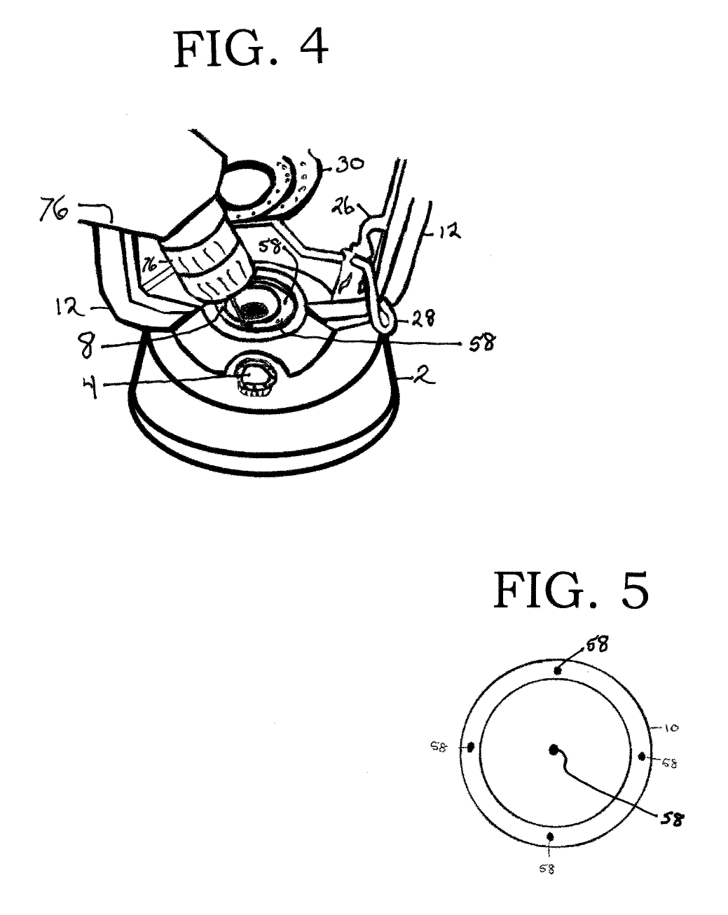

FIG. 4 is the lower lantern unit specifically base 2 illustrating one of many methods of incorporating drain holes 58 into lowest levels of base burner well 8. The addition of drain holes 58 eliminates the accumulation of moisture and its resulting damage adding to the longevity of solar lantern and all components of solar light bulb 60. An improvement to the present invention is to ensure drain holes 58 are incorporated into certain components of solar lantern. For purposes of illustration, a handheld drill with bit 76 is shown. Alternative methods of incorporating or drilling drain holes 58 into base burner well 8 include drill press, punch, mold or variations thereof in pre or post production. Drain holes 58 may be as few as one but several around the lower ring of base burner well 8 with drain holes 58 width of approximately ⅛″ or thereabouts conducive to optimum drainage and airflow. For perspective purposes in identifying base burner well 8 and location of drain holes 58, FIG. 4 illustrates base 2, tubes 12, lift collar notch 26, lift lever assembly 28, globe supporting plate 30 and screw cap 4.

FIG. 5 represents base plate 10 as attached to underneath or bottom of base 2 upon which solar lantern sits. Drain holes 58 incorporated into base plate 10 at lowest levels when solar lantern upright. Metal tends to produce condensation in humid conditions and the solar lanterns, by virtue of being outdoors, will be subjected to precipitation in form of rain, snow and sleet. By incorporating appropriate drainage in base 2, moisture accumulation will be nominal, thereby preventing/deterring rust, eliminating ice expansion and resulting damage. In addition, drain holes 58 added to base 2 and base burner well 8 also serve as air holes contributing to air movement within the solar lantern further encouraging evaporation of moisture. Drain holes 58 may be as many as appropriate as determined by size of base 2 of solar lantern and mindful of integrity of base plate 10. By way of example, four to five drain holes 58 with width of drain holes 58 ranging from ¼″ to ⅛″ or thereabouts more than adequate for optimal drainage and airflow without compromising integrity of individual component. Drain holes 58 may be drilled, punched, molded or any variations thereof for like results into base plate 10 in pre or post production as appropriate.

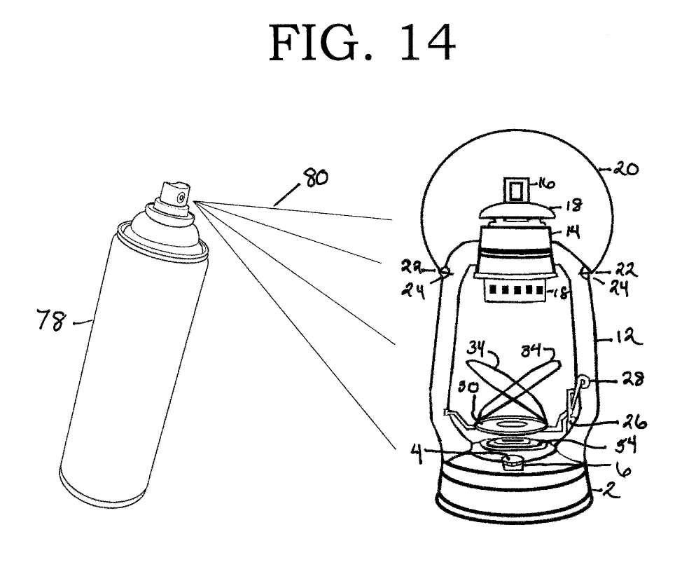

FIG. 6 illustrates lower lantern unit specifically base 2 illustrating an improvement to the present invention of addition of base flange 54 or cover to be placed over base burner well 8 and its drain holes 58 to act as a shield from the elements while allowing air movement. Base flange 54 may be comprised of a pipe flange commonly available in retail plumbing as a 1-¼″ flange or use of electrical reducing washer of similar size which incorporates a center opening of approximately 1-¼″, hereinafter referred to as base flange 54, an improvement to invention, further detailed in FIGS. 7-8. Base flange 54 may be constructed to seat over base burner well 8 and not be firmly attached to base 2, but moveable to accommodate the later installation of solar light bulb 60 and its battery housing 68 into base 2. In addition, the non-attachment of base flange 54 to base 2 conducive to ease in removing any leaves or outdoor debris as common in outdoor settings which may naturally collect in base burner well 8. Modifications include construction of base flange 54 to either fit or snap snugly onto base burner well 8 of base 2; incorporate a hinge attachment connecting base flange 54 to base 2; screw on and variations thereof which allows access to an otherwise sealed base burner well 8. Base flange 54 may be constructed with components from common burner assembly 52 further detailed in FIGS. 9-12. Base 2 may be molded to eliminate base burner well 8 entirely. Base flange 54 may be treated with exterior paint/finish or specialty coating 80 further detailed in FIG. 14. FIG. 6 incorporates for perspective purposes base flange 54 centered over base burner well 8 as seated on base 2, tubes 12, lift collar notch 26, lift lever assembly 7, globe supporting plate 30, wire globe guards 34 and screw cap 4.

FIG. 7 depicts overhead or top view of base flange 54 comprised of commonly available electrical reducing washer with recommended center opening of approximately 1-¼″ with outer diameter of 2-½″ to 3″ or thereabouts provides precipitation and debris deflection when placed over base burner well 8, held in place by battery housing 68 within rod tube 74 of inserted solar light bulb 60 in lantern's ready to use state.

FIG. 8 depicts side of base flange 54 comprised of a pipe flange commonly available in retail plumbing as a 1-¼″ pipe flange, its outer diameter of 3- 1/16″ found to fit over and on top of base burner well 8; and inward sloping sides culminating to ½″ height. In addition to providing precipitation and debris deflection, the overall style of 1-¼″ pipe flange resembles overall shape of common burner assembly 52 while complimenting the lantern's classic design.

FIGS. 9 through 12 depict adaptation of common burner assembly 52 to be used as base flange 54 for purpose of more closely resembling original and recognizable design of traditional fuel burning lanterns. FIG. 9 incorporates only burner collar 44 with attached key 50 centered over base burner well 8 covering drain holes 58 as attached to base 2. Key 50 is non-operational and attached to burner collar 44 for aesthetics. For perspective purposes, FIG. 9 illustrates lower solar lantern assembly as shown with tubes 12, lift collar notch 26, lift lever assembly 7, globe supporting plate 30, wire globe guards 34 and screw cap 24. For purposes of clarity, adapted burner collar 44 hereinafter referred to as base flange 54.

FIG. 10 depicts a method of adapting or converting common burner assembly 52 comprised of burner cone 42, collar 44, burner wick shaft with latching assembly 46, wick 48 and key 50 to useable base flange 54. This includes removal of burner cone 42, burner wick shaft with latching assembly 46 from burner collar 44; elimination of wick 48; and, if desired, incorporation of key 50 to burner collar 44.

FIG. 11 illustrates side view of converted burner collar 44 and attached key 50 as described in FIG. 10.

FIG. 12 depicts an overhead view of burner collar 44 without key 50 attached.

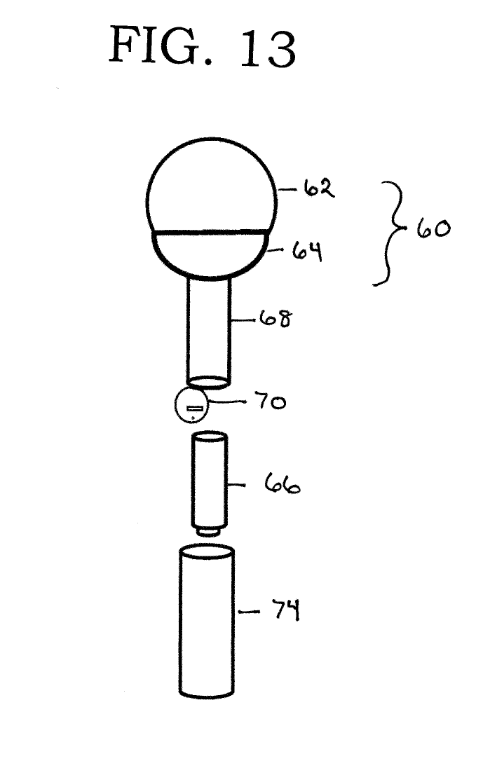

FIG. 13 illustrates solar light bulb 60 utilized in solar lantern comprised of one more solar cells aka amorphous solar panel, photo-resistor arranged to recharge the battery and power the LEDs, and light emitting diode(s) or LED bulb facing upward contained on top of and within solar housing 64 encased within clear crackle ball glass lens 62 of approximately 2.36″/2-⅛″ diameter referenced as Petite; or, 3.15″/3-⅛″ diameter referenced as Large. Rechargeable battery 66 inserted into battery housing 68, held in place by closing and fastening battery cover and screw 70 containing positive battery connection, attached to lowest end of battery housing 68. Battery tab 72 provides break of connection when placed between rechargeable battery 66 and battery cover and screw 70, as included in purchase of new solar light bulb 60. Battery tab 72 removed prior to initial use. Solar housing 64 of Large solar light bulb 60 currently manufactured of dark bronze or silver metal. Solar housing 64 of Petite solar light bulb 60 currently manufactured of black hard plastic.

Solar light bulb 60 utilized in the present invention currently manufactured and sold as outdoor garden path lights and contain hollow tube of materials and color matching solar housing 64 for insertion of and to hold battery housing 68 with removable plastic garden stake. Battery housing 68 is inserted vertically into hollow tube; garden stake inserted at opposite end of hollow tube and driven into ground. It is found Petite hollow tube generally comprised of hard plastic, predominantly black in color; Large hollow tube generally comprised of aluminum metal alloy, predominantly dark bronze or silver in color. It is found hollow tube currently provided with these types of solar light bulbs 60 may be used as rod tube 74 in solar lantern as cover for battery housing 68 with modification and is an improvement to the present invention.

Battery housing 68 sizes of solar light bulbs 60 referenced and currently manufactured are Petite: approximately 11/16″/17 mm diam.×1-¾″/4.2 cm high to house AAA rechargeable battery 66; Large battery housing 68 approximately 13/16″/2.1 cm diam.×1-¾″/4.2 cm high, to house AA rechargeable battery 66, both comprised of hard plastic, predominantly black in color. Petite hollow rod 18 mm inside diam./2 cm outside diam.×17 cm length; Large hollow rod 2.3 cm inside diam./2.4 cm outside diam.×18.5 cm length. An improvement to the present invention is to establish standard universal sizes of Large and Petite, generally referring to overall dimension of battery housing 68 required to contain AA or AAA rechargeable battery 66 and size of solar housing 64 and clear crackle ball glass lens 62 of approximately 2.36″ diameter referenced as Petite; and, 3.15″ diameter referenced as Large, and corresponding rod tube 74, be adopted for use in solar lanterns.

Size of solar light bulb 60 used in solar lantern determined by inside diameter of globe base 38 opening or inside diameter globe top rim 40 opening of globe 36. It is noted Petite solar light bulb 60 may be universally utilized as it is found globe base 38 of all size globes 36 will fit over its clear crackle ball glass lens 62 of approximately 2.36″ or 2-⅛″ diameter. Large solar light bulb 60, as currently manufactured, may be utilized when globe base 38 or globe top rim 40 inside diameter opening larger than 3.15″ or 3-⅛″. It is noted that large solar light bulb 60 provides more powerful illumination capabilities as provided by its larger AA rechargeable battery 66.

An improvement to invention is to modify clear crackle ball glass lens 62 of Large solar light bulb 60 to a more lineal, narrow shape of a diameter slightly smaller than globe base 38 of globes 36 currently manufactured. Large solar housing 64 current diameter of approximately 2-⅝″ fits within inside diameter of opening of globe 36 currently and traditionally utilized in this invention. Modification of its clear crackle ball glass lens 62, and/or solar housing 64 diameter, such as to a candle flame or flower bud, combo of both, Edison style, teardrop, or torpedo, faceted, crackle, or other design or variation of glass, high quality, durable, scratch free clear or faceted plastic, Pyrex® or other material suitable and appropriate for outdoor use of a maximum diameter appropriate and approximately affording its use in all globes 36 currently manufactured, regardless of globe base 38 size. Clear crackle ball glass lens 62 of petite solar light bulb 60 and/or its solar housing 64 may be similarly modified in shape to enhance overall look of solar lantern, although current size requires no modification.

Rod tube 74 may be comprised of the provided hollow rod, modified to length of 1-¾″, to contain entire battery housing 68 and act as decorative cover for battery housing 68 providing protection from the elements, an improvement to the present invention. Use of rod tube 74 over battery housing 68 contributes to a more cohesive, high quality and finished look of solar light bulb 60 as utilized in solar lantern and may be enhanced in its design, further detailed in FIGS. 14-18.

It is noted, as currently manufactured, large solar light bulb 60 weighs approximately 0.25 kg or 0.5 lbs. with rechargeable battery 66 and petite solar light bulb 60 weighs 0.15 kg or 0.3 lb. with rechargeable battery 66. Weight of solar light bulb 60 should be factored into overall weight of solar lantern for stability, shipping and hanging purposes.

An improvement to invention is to replace the NiCd rechargeable battery 66 commonly provided with solar light bulb 60 with a NiMh (Nickel Metal Hydride) rechargeable battery 66 which deliver more power lasting hours longer in these full drain devices, and can be charged up to 1000 times providing three to four years of daily use. NiCd rechargeable batteries 66 contain cadmium which is hazardous to the environment. NiMh rechargeable batteries 66, free of toxic or hazardous elements such as cadmium, lead, mercury or lithium, can be disposed of safely. An improvement to invention is that components comprising solar light bulb 60 be recyclable.

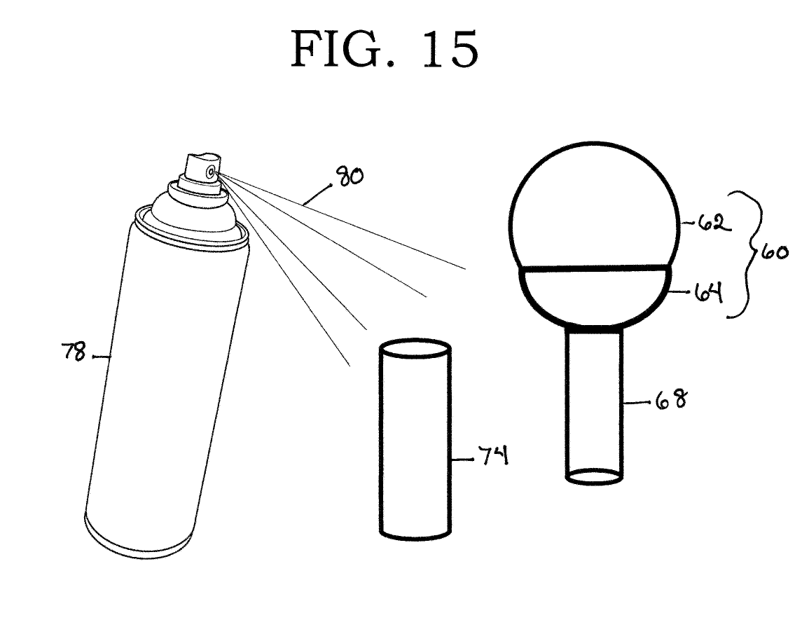

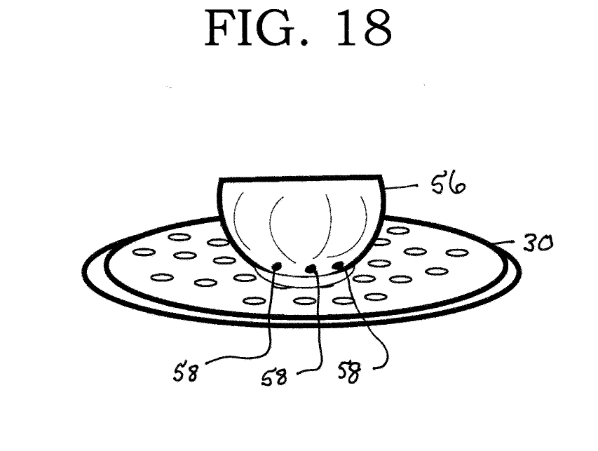

FIG. 14 illustrates an alternative improvement and sample method of improvement of lantern of FIGS. 1 and 18 depicting addition of an exterior paint/finish or specialty coating 80, referencing clear coats and color, to all metal parts of lantern in FIGS. 1 and 18 to retard rusting and corrosion in the event an exterior finish has not been utilized. Where an exterior finish or exterior color is already incorporated into specifications of lantern production, addition of exterior paint/finish or specialty coating 80 to entire lantern will not be necessary. In that instance, this step may be utilized to newly added or adapted base flange 54 to complement individual lantern in color or to match current protective finishes. It is noted exterior paint/finish or specialty coating 80 may be applied to interior of all metal components such as base 2, tubes 12, chimney 18 and top 14 further providing rust protection. While addition of an exterior finish is not necessary to solar light bulb 60, an optional improvement is to add exterior paint/finish or specialty coating 80 to solar housing 64 of solar light bulb 60 and its battery housing 68, and/or rod tube 74 covering battery housing 68, which matches or complements lantern color and finish as further detailed in FIG. 15. Spray can 78 is illustrated for demonstration purposes and meant to encompass all variations of application and manufacturing methods, including, but not limited to, power coating, baking, dipping, and spraying of exterior paint/finish or specialty coating 80 thereof in pre or post production.

The present invention particularly conducive to associating with product, sports or theme branding, appealing to collectors of same and is an improvement to invention. Solar lantern may be treated with exterior paint/finish or specialty coating 80 in brand or theme colors representative and associated with certain brands or themes. Further, decals 82, incorporating stickers, medallions, figurines or any other item appropriate to branding or theme, manufactured for outdoor use, or treated with exterior paint/finish or specialty coating 80, may be added to base 2 and globe 36 or other components of solar lantern in representation of brand or theme.

FIG. 15 illustrates an improvement and sample method of improvement of lantern of FIG. 1 depicting addition of exterior paint/finish or specialty coating 80 to solar housing 64 of solar light bulb 60 to complement individual lantern in color or protective finish. An optional improvement is to also add exterior paint/finish or specialty coating 80 to battery housing 68. Solar lights of this type are currently sold with a rod tube 74 covering battery housing 68. This rod tube 74 may be eliminated or cut to a length the approximate length of battery housing 68 so as to allow easy access to the battery panel and not interfere with insertion in lantern, detailed in FIG. 13-14. Rod tube 74 provides additional weather protection to battery housing 68. Thus, an improvement to invention is the shortened rod tube 74 and/or addition of exterior paint/finish or specialty coating 80 to rod tube 74 and/or solar light bulb 60 in color and/or finish which matches or complements lantern. Spray can 78 is illustrated for demonstration purposes and meant to encompass all variations of application and manufacturing methods, including, but not limited to, power coating, baking, dipping and spraying of exterior paint/finish or specialty coating 80 thereof in pre or post production.

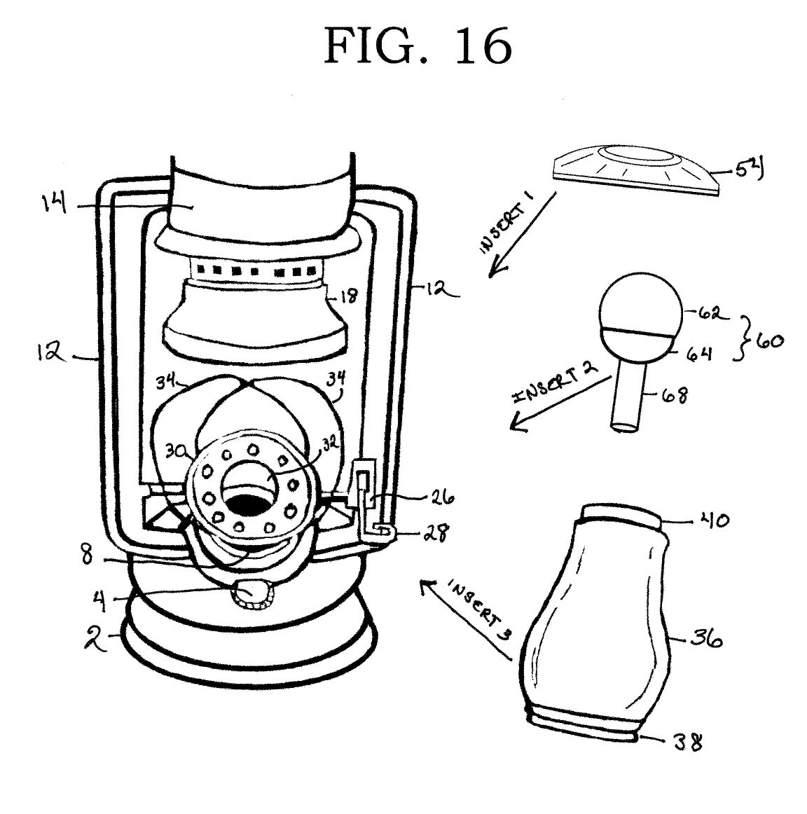

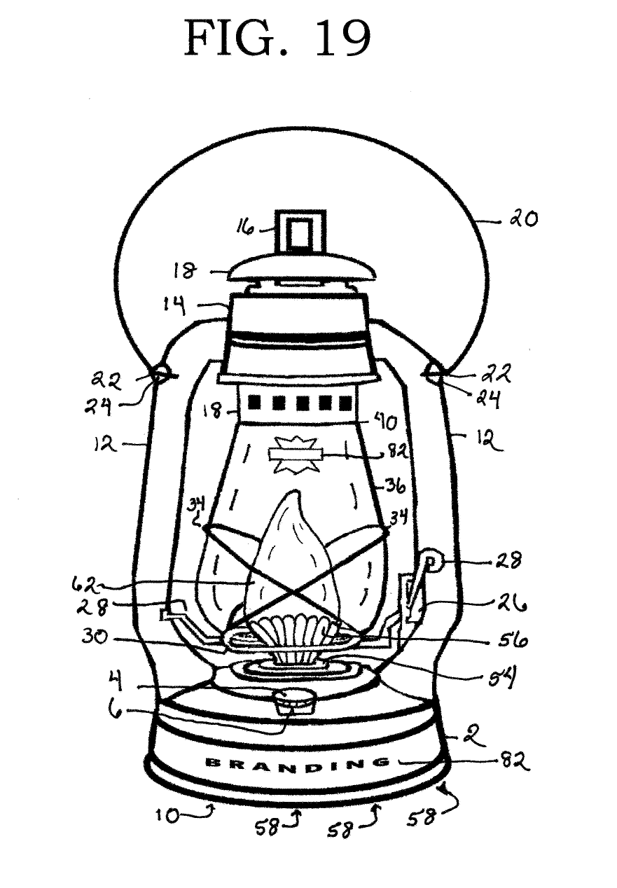

FIG. 16 illustrates a method of inserting a solar light bulb 60 into solar lantern as shown in FIGS. 1 and 19 prior to placement and insertion of globe 36 in instances where globe 36 is a standard or common tall size of approximately 5-¼″ to 6-¼″ height. FIG. 16 incorporates, for perspective purposes, base 2, tubes 12, lower portion of top 14, lower portion of chimney 18, lift collar notch 26, lift lever assembly 28, globe supporting plate 30, wire globe guards 34, screw cap 4, base flange 54, base burner well 8, drain holes 58 in base burner well 8, solar light bulb 60 and its battery housing 68 to which is attached temporary battery tab 72, removed to activate battery connection, and globe 36.

For this method, base flange 54 centered and placed over base burner well 8. Remove battery tab 72 from battery housing 68 thereby activating connection of battery to solar light bulb 60. With lift lever assembly 28 notched downward in lift collar notch 26, insert solar light bulb 60 on top of globe supporting plate 30 with its battery housing 68 positioned vertically downward passing through globe plate center hole 32 of globe supporting plate 30, base flange 54 and base burner well 8 into base 2. Raise chimney 18 and hold. Place globe 36 centered over solar light bulb 60 on top of globe supporting plate 30 between wire globe guards 34. Release lift lever assembly 28 upwards and position globe 36 upright while on globe supporting plate 30 surrounding inserted solar light bulb 60. Gently lower chimney 18 to firmly seat globe top rim 40 of globe 36 into chimney 18. Solar lantern ready for use.

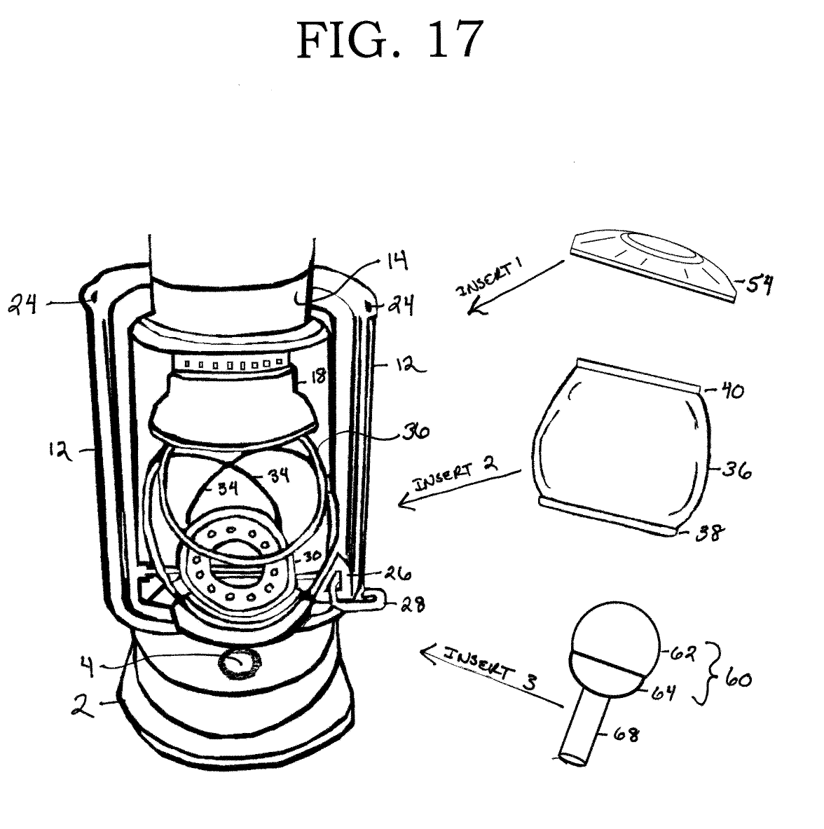

FIG. 17 illustrates a method of inserting a solar light bulb 60 into solar lantern as shown in FIGS. 1 and 19 following placement of globe 36 onto globe supporting plate 30 as an alternative to method described in FIG. 17 and maybe more useful in instances where globe 36 is the shorter version, being 3″ to 4-¾″, or thereabouts, in height, and/or globe top rim 40 is wider than globe base 38. FIG. 17 incorporates, for perspective purposes, base 2, tubes 12, lower portion of top 14, lower portion of chimney 18, lift collar notch 26, lift lever assembly 28, globe supporting plate 30, wire globe guards 34, screw cap 4, base flange 54, base burner well 8, drain holes 58 in base burner well 8, solar light bulb 60 to which is attached temporary battery tab 72 removed to activate battery connection and globe 36.

For this method, base flange 54 placed and centered over base burner well 8. With lift lever assembly 28 notched downward in lift collar notch 26, place globe 36 on top of globe supporting plate 30 between wire globe guards 34. Remove battery tab 72 from battery housing 68 thereby activating connection of battery to solar light bulb 60. Insert solar light bulb 60 inside globe 36 with its battery housing 68 positioned vertically downward passing through globe plate center hole 32 of globe supporting plate 30, base flange 54 and base burner well 8 into base 2. Raise chimney 18 and hold. Release lift lever assembly 28 upward and position globe 36 upright while on globe supporting plate 30. Gently lower chimney 18 to firmly seat globe top rim 40 of globe 36 into chimney 18. Solar lantern ready for use.

FIG. 18 illustrates addition of solar housing cup 56 attached to edge or within globe plate center hole 32 of upper globe supporting plate 30, cradle or otherwise hold solar light bulb 60 within globe 36, an improvement to invention. Solar housing cup 56 of approximate and corresponding dimension of solar housing 64 of solar light bulb 60, with center opening width to allow insertion and passage of battery housing 68 and/or surrounding rod tube 74. Solar housing cup 56 may extend slightly upwards and/or outwards around lower edge of clear crackle ball glass lens 62. Solar housing cup 56 may contain drain holes 58 at its lower level to deter moisture accumulation and aid in air circulation. Solar housing cup 56 may be decorative in nature, particularly useful in disguising color of solar housing 64 as currently available and as described in FIG. 13. Solar housing cup 56 attached directly to rim of globe plate center hole 32 on top globe supporting plate 30. Solar housing cup 56 may be constructed so as to firmly envelop, grip, cradle or otherwise cause solar housing 64 of solar light bulb 60 to set or settle solar light bulb 60 in correct position on globe supporting plate 30 when solar lantern assembled and ready for use as detailed in FIGS. 16, 17 and 19. Weight of solar light bulb 60 and its battery housing 68 in rod tube 74 extending downward into base 2, will aid solar light bulb 60 to settle or position correctly in solar housing cup 56 and particularly more securely if solar housing cup 56 of size and shape to surround solar housing 64. Exterior paint/finish or specialty coating 80 may be applied to rod tube 74 and solar housing cup 56 to match or complement solar lantern, as detailed in FIGS. 13-15, wherein currently manufactured solar light bulb 60 may be used with its solar housing 64 and battery housing 68 unseen.

FIG. 19 illustrates an exploded side view of solar lantern of FIG. 1 in its ready for use state with addition of exterior paint/finish or specialty coating 80 on all components, decals 82 on globe 36 and base 2, utilizing Large solar light bulb 60, with its clear crackle ball glass lens 62 modified to new shape of candle flame, cradled in solar housing cup 56 as attached to globe plate center hole 32 on globe supporting plate 30, with battery housing 68 within rod tube 74 as inserted through base flange 54 as placed onto center base burner well 8, further described in FIGS. 13-16 and 18.

Components illustrated are base 2 with lower base plate 10 containing drain holes 58, base burner well 8, containing drain holes 58, covered with base flange 54. Fuel tank opening 6 capped with screw cap 4. Tubes 12 attached to either side base 2 leading into and attached to open cylindrical top 14. Spring pressed chimney 18 vertically in top 14 into which globe top rim 40 of globe 36 inserted and held firmly. Attached to one of two lower side tubes 12 is lift collar notch 26 through which lift lever assembly 28 is threaded. Lift lever assembly 28 attached to globe supporting plate 30. Wire globe guards 34 attached to globe supporting plate 30 provide additional stability to globe 36. Bail ears 22, at outer ends of bail handle 20, inserted into bail ears slots 24 molded into upper side tubes 12; ring tab with hinge 16 attached to top chimney 18. Inside globe 36, as seated within solar housing cup 56 on globe supporting plate 30, solar light bulb 60 and rod tube 74 over battery housing 68 with battery housing 68 positioned vertically downward through globe plate center hole 32, through base flange 54 and base burner well 8 into base 2, further detailed in FIGS. 1-18.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

1. A system for converting a lighting fixture to a solar light fixture comprising:
a rod tube, a solar housing cup, a base flange, and a solar light fixture;
wherein the solar light fixture has a solar light bulb and a housing extending from the solar light bulb;
the rod tube having a hollow interior and a first end and a second end, wherein the first end of the rod tube has an opening to a hollow interior of the rod tube and the second end of the rod tube has an opening to the hollow interior of the rod tube;
a solar housing cup being generally a cup shaped with a first end, second end, and middle, wherein the first end of the solar housing cup has an opening and the second end of the solar housing cup has an opening whereby both are joined by the middle hollow interior of the solar housing cup;
a base flange, having a first end and a second end, wherein the first end of the base flange has an inside opening and the second end has an outer rim;
wherein the solar light fixture has a housing extension that is removably insertable into the hollow interior of the rod tube, the solar housing cup, and a center hole of the base flange

2. The system of claim 1, wherein the rod tube extends beyond the housing of the solar light fixture.

3. The system of claim 1, wherein the outer rim of the base flange is located at the gravitational bottom of the center opening of the base flange.

4. The system of claim 1, wherein the base flange is coupled to the lighting fixture.

5. The system of claim 4, wherein the base flange is mechanically coupled to the lighting fixture by welding, gluing, molding, tabbing, screwing, bolting, hinging.

6. The system of claim 1, wherein the solar housing cup is coupled to the lighting fixture.

7. The system of claim 6, wherein the solar housing cup is mechanically coupled to the lighting fixture by welding, gluing, molding, tabbing, screwing, bolting, hinging.

8. A method for converting a lighting fixture to a solar light fixture comprising:
removing a burner assembly from the lighting fixture to expose a base burner well and a fuel base;
providing a rod tube having a first end and a second end, wherein the first end of the rod tube has an opening to a hollow interior of the rod tube and the second end of the rod tube has an opening to the same hollow interior of the rod tube;
providing a solar housing cup that is generally cup shaped and has a first end, a second end, and a middle, wherein the first end has an opening and the second end has an opening ,wherein the first end and the second end are joined by the middle hollow interior of the solar housing cup;
providing a base flange having a first end and a second end, wherein the first end of the base flange has an inside opening and the second end has an outer rim;
providing a solar light fixture having a solar light bulb and a housing extending from the solar light bulb;
removably inserting the housing of the solar light fixture into the hollow interior of the rod tube,
removably inserting the rod tube into center opening of the solar housing cup, and,
removably inserting the rod tube into center opening of base flange into the fuel base.

9. The method of claim 8, wherein the gravitational bottom of the fuel base includes a drain

10. The method of claim 8, wherein the solar housing cup has a center opening large enough to insert the rod tube.

11. The method of claim 10, wherein the solar housing cup has at least one drainage hole.

12. The method of claim 11, wherein the drainage hole of solar housing cup is located along a gravitational bottom of the solar cup housing.

13. The method of claim 8, wherein the solar housing cup has an interior that is shaped to cradle the solar light fixture;

14. The method of claim 8, wherein the base flange has a center opening large enough to insert the rod tube.

15. The method of claim 14, wherein the outer rim of the base flange is large enough to cover the exposed base burner well and the fuel base.

16. The method of claim 8, wherein the solar light fixture includes a globe, wherein the globe has a flame shape.

17. A system for converting a lighting fixture to a solar light fixture comprising:
a rod tube, a base flange and a solar light fixture;
removing a burner assembly from the lighting fixture to expose a base burner well and a fuel base;
providing a rod tube having a first end and a second end, wherein the first end of the rod tube has an opening to a hollow interior of the rod tube and the second end of the rod tube has an opening to the hollow interior of the rod tube;
providing a base flange having a first end and a second end, wherein the first end of the base flange has an opening for insertion of housing extension of the solar light fixture and the second end having an outer rim large enough to cover the base burner well and the fuel base;
providing a solar light fixture having a solar light bulb and a housing extending from the solar light bulb;
removably inserting the housing of the solar light fixture into the hollow interior of the rod tube,
removably inserting the rod tube through center opening of a globe plate; and,
removably inserting the rod tube through a center of base flange.

18. The system of claim 17, wherein the gravitational bottom of the base burner well contains a drain.

19. The system of claim 17, wherein the base flange is placed onto the base burner well and the fuel base surrounding the rod tube.

20. The system of claim 19, wherein the base flange is placed onto the base burner well and the fuel base surrounding the housing extension of the solar light fixture.
